(19) United States
(12) Patent Application Publication
(10) Pub. No.: US 2015/0170052 A1
(43) Pub. Date: Jun. 18, 2015

(54) METHOD OF REDUCING RESOURCE FLUCTUATIONS IN RESOURCE LEVELING

(71) Applicant: KING FAHD UNIVERSITY PETROLEUM AND MINERALS, Dhahran (SA)

(72) Inventors: Mohammed ABDUL RAHMAN, Riyadh (SA); Ashraf Mohamed ELAZOUNI, Kanata (CA)

(73) Assignee: KING FAHD UNIVERSITY PETROLEUM AND MINERALS, Dhahran (SA)

(21) Appl. No.: 14/104,819

(22) Filed: Dec. 12, 2013

(51) Int. Cl. G06N 99/00

(52) U.S. Cl. CPC G06N 99/005

(57) ABSTRACT

The invention relates to a method of reducing the fluctuation in resource profile allows exploring solutions beyond the original project duration resource. The computer-implemented method includes the following steps: providing computer processing means and computer readable media; inputting a data set including a list of projects, a list of activities to complete the project, duration data, sequence data, a genetic algorithm (GA), an schedule extension scheme, a representation method, an algorithm of generating chromosome of initial population, a selection method of chromosome for reproduction, a resource leveling metric and a cross-over percentage and a mutation percentage; setting an extension increment associated with each project of the data set; formulating a genetic algorithm based model associated with each project of the data set and the GA; calculating an evaluation metric value for the project based on the GA model; and displaying an evaluation table, which is arranged with the evaluation metric values and durations. The method allows for searching the schedules of reduced resource leveling fluctuation beyond the original duration, and provides users the schedules with low resource fluctuation and more efficient utilization of resources.

FIELD OF INVENTION

The present invention relates to a method for resource leveling, with the aim of providing practitioners with schedules of low resource fluctuation in unconstrained—resource conditions.

### BACKGROUND OF THE INVENTION

A genetic algorithm (GA) is a search technique used in computing to find exact or approximate solutions to optimization and search problems. Genetic algorithms are categorized as global search heuristics. Genetic algorithms are a particular class of evolutionary algorithms (EA) that use techniques inspired by evolutionary biology, such as inheritance, mutation, selection, and crossover.

Genetic algorithms are implemented in a computer simulation in which a population of abstract representations (called chromosomes or the genotype of the genome) of candidate solutions (called individuals, creatures, or phenotypes) to an optimization problem evolves toward better solutions. Traditionally, solutions are represented in binary as strings of 0s and 1s, but other encodings are also possible. The evolution usually starts from a population of randomly generated individuals and happens in generations. In each generation, the fitness of every individual in the population is evaluated, multiple individuals are stochastically selected from the current population (based on their fitness), and modified (recombined and possibly randomly mutated) to form a new population. The new population is then used in the next iteration of the algorithm. Commonly, the algorithm terminates when either a maximum number of generations has been produced, or a satisfactory fitness level has been reached for the population. If the algorithm has terminated due to a maximum number of generations, a satisfactory solution may or may not have been reached.

Genetic algorithms find application in bioinformatics, phylogenetics, computational science, engineering, economics, chemistry, manufacturing, mathematics, physics and other fields. A typical genetic algorithm requires a genetic representation of the solution domain and a fitness function to evaluate the solution domain.

A standard representation of the solution is as an array of bits. Arrays of other types and structures can be used in essentially the same way. The main property that makes these genetic representations convenient is that their parts are easily aligned due to their fixed size, which facilitates simple crossover operations. Variable length representations may also be used, but crossover implementation is more complex in this case. Tree-like representations are explored in genetic programming and graph-form representations are explored in evolutionary programming.

In genetic algorithms, crossover is a genetic operator used to vary the programming of a chromosome or chromosomes from one generation to the next. It is analogous to reproduction and biological crossover, upon which genetic algorithms are based. In a “one-point” crossover, a single crossover point on both parents' organism strings is selected. All data beyond that point in either organism string is swapped between the two parent organisms. The resulting organisms are the children.

Two-point crossover calls for two points to be selected on the parent organism strings. Everything between the two points is swapped between the parent organisms, rendering two child organisms. Another crossover variant, the “cut and splice” approach, results in a change in length of the children strings. The reason for this difference is that each parent string has a separate choice of crossover point. In the above schemes, the two parents are combined to produce two new offspring.

In the “uniform crossover” scheme (UX), individual bits in the string are compared between two parents. The bits are swapped with a fixed probability, typically 0.5. In the half uniform crossover scheme (HUX), exactly half of the non-matching bits are swapped. Thus, first, the Hamming distance (i.e., the number of differing bits) is calculated. This number is divided by two. The resulting number is how many of the bits that do not match between the two parents will be swapped.

Depending on how the chromosome represents the solution, a direct swap may not be possible. One such case is when the chromosome is an ordered list, such as an ordered list of the cities to be traveled for the traveling salesman problem. A crossover point is selected on the parents. Since the chromosome is an ordered list, a direct swap would introduce duplicates and remove necessary candidates from the list. Instead, the chromosome up to the crossover point is retained for each parent. The information after the crossover point is ordered as it is ordered in the other parent. For example, if our two parents are ABCDEFGHI and IGAHFDBEC and our crossover point is after the fourth character, then the resulting children would be ABCDIGHFE and IGAHBCDEF.

The “fitness function” is defined over the genetic representation and measures the quality of the represented solution. The fitness function is always problem dependent. For example, in the knapsack problem, one wants to maximize the total value of objects that can be put in a knapsack of some fixed capacity. A representation of a solution might be an array of bits, where each bit represents a different object, and the value of the bit (0 or 1) represents whether or not the object is in the knapsack. Not every such representation is valid, as the size of objects may exceed the capacity of the knapsack. The fitness of the solution is the sum of values of all objects in the knapsack if the representation is valid, or 0 otherwise. In some problems, it is hard or even impossible to define the fitness expression; in these cases, interactive genetic algorithms are used.

Once the genetic representation and the fitness function are defined, GA proceeds to initialize a population of solutions randomly, then improve it through repetitive application of mutation, crossover, inversion and selection operators. Initially, many individual solutions are randomly generated to form an initial population. The population size depends on the nature of the problem, but typically contains several hundreds or thousands of possible solutions. Traditionally, the population is generated randomly, covering the entire range of possible solutions (i.e., the “search space”). Occasionally, the solutions may be “seeded” in areas where optimal solutions are likely to be found.

During each successive generation, a proportion of the existing population is selected to breed a new generation. Individual solutions are selected through a fitness-based process, where fitter solutions (as measured by a fitness function) are typically more likely to be selected. Certain selection methods rate the fitness of each solution and preferentially select the best solutions. Other methods rate only a random sample of the population, as this process may be very time-consuming.

Most functions are stochastic and designed so that a small proportion of less fit solutions are selected. This helps keep the diversity of the population large, preventing premature convergence on poor solutions. Popular and well-studied selection methods include roulette wheel selection and tournament selection.

The next step is to generate a second generation population of solutions from those selected through genetic operators: crossover (also called recombination), and/or mutation. For each new solution to be produced, a pair of “parent” solutions is selected for breeding from the pool selected previously. By producing a “child” solution using the above methods of crossover and mutation, a new solution is created which typically shares many of the characteristics of its “parents”. New parents are selected for each child, and the process continues until a new population of solutions of appropriate size is generated. Although reproduction methods that are based on the use of two parents are more “biology inspired”, recent research suggests more than two “parents” are better to be used to reproduce a good quality chromosome.

These processes ultimately result in the next generation population of chromosomes that is different from the initial generation. Generally, the average fitness will have increased by this procedure for the population, since only the best organisms from the first generation are selected for breeding, along with a small proportion of less fit solutions, for the reasons noted above.

This generational process is repeated until a termination condition has been reached. Common terminating conditions include: a solution is found that satisfies minimum criteria; a fixed number of generations are reached; an allocated budget (computation time/money) is reached; the highest ranking solution's fitness is reaching or has reached a plateau such that successive iterations no longer produce better results; manual inspection or combinations of the above.

The process generally follows the steps of Choose the initial population of individuals; evaluate the fitness of each individual in that population; repeat on this generation until termination; select the best-fit individuals for reproduction; breed new individuals through crossover and mutation operations to give birth to offspring; evaluate the individual fitness of new individuals; and replace least-fit population with new individuals.

In genetic algorithms, mutation is a genetic operator used to maintain genetic diversity from one generation of a population of chromosomes to the next. It is analogous to biological mutation. An example of a mutation operator is a probability that an arbitrary bit in a genetic sequence will be changed from its original state. A common method of implementing the mutation operator involves generating a random variable for each bit in a sequence. This random variable tells whether or not a particular bit will be modified.

The purpose of mutation in GAs is to allow the algorithm to avoid local minima by preventing the population of chromosomes from becoming too similar to each other, thus slowing or even stopping evolution. This reasoning also explains the fact that most GA systems avoid only taking the fittest of the population in generating the next, but rather a random (or semi-random) selection with a weighting toward those that are fitter.

As noted above, in GAs, potential solutions to a problem are represented as a population of chromosomes. Each chromosome in turn is composed of a string of values each is being referred to as a gene. The chromosomes evolve through successive generations. In order to exploit and explore potential solutions, offspring chromosomes are created by merging two parent chromosomes using a crossover operator or modifying an existing chromosome using a mutation operator. There are many methods of crossover and mutation operators.

The method of gene coding in a chromosome hinges upon the particular problem at hand. The typical time/cost trade-off problem can be formulated as a numerical optimization problem in the GAs. In this particular problem, the values of the genes in a chromosome represent possible durations of the project activities. The one-cut-point crossover and uniform mutation operators can be used efficiently for the time/cost trade-off problems. Resource allocation problems represent a typical ordering problem, as the main concern is to determine the activities' priority to fulfill the constrained resources. Accordingly, the genes represent activities' identifications and a chromosome represents a possible order of activities. A chromosome structure can be such that an activity in a higher order, from left to right, has a higher priority of getting resources than the previous activities. However, there is a possibility that character duplication and/or omission occurs after implementing the crossover and mutation operators.

Likewise, the unlimited resource leveling problem can be translated into a normal numerical optimization problem using GA techniques. Resource leveling problems represent a typical scheduling problem with the objective of minimizing the fluctuation in resource usage. The genes represent activities' start times and a chromosome represents a possible project schedule. In contrast with ordering problems, scheduling problems features specific precedence relationships among genes. Accordingly, the implementation of the one-cut-point crossover and uniform mutation operators for the leveling problem may cause violation of the precedence relationships of the offspring chromosomes. This problem entails checking the output chromosomes of the crossover and mutation operators and repairing of the infeasible chromosomes. This check/repair process causes considerable computational inefficiency to the GA technique.

It would be desirable to generate and employ precedence-preserving crossover and mutation operators for chromosomes encoding activities' start times to avoid the inefficiency caused by the basic GAs technique, through detecting and repairing the infeasible chromosomes each time these operators are performed.

Resource Leveling is related to the planning of construction projects which aims at reducing undesirable resource fluctuations in order to produce cost-effective and productive construction schedules as described in Zhao et al. (“GA-Based Resource Leveling Optimization for Construction Project,” International Conference on Machine Learning and Cybernetics, Aug.2004, pp. 2363-2367—incorporated herein by reference). Efficient resource leveling avoids disruptive work schedules, minimizes idle resource time and reduces release and re-hire of temporary workforce as described in El-Rayes et al. (“Optimizing Resource Leveling in Construction Projects,” Journal of Construction Engineering and Management, Vol. 135, No. 11, June 2009, pp. 1172-1180—incorporated herein by reference). Hinze (“Construction planning and scheduling”, Prentice Hall, 2008—incorporated herein by reference) describes and differentiates resource allocation which refers to the allocation of resources when their availability is limited; and resource leveling which refers to the efficient usage of required resources when the project duration is fixed. Resource allocation is frequently called resource-constrained scheduling or simply resource scheduling while resource leveling is called time-constrained scheduling according to Savin et al. (“A procedure for calculating the weight matrix of a neural network for resource leveling,” Advances in Engineering Software, Vol. 28, No. 5,1997, pp. 277-283—incorporated herein by reference).

The resource leveling has been consistently performed while the original project duration remained intact. However, some practitioners would be flexible to accept schedules with some extension in the original project duration should considerable enhancements in resource leveling featured in smoother resource profiles be attained. This premise establishes a need for a scheduling tool which explores solutions beyond the original project duration exhibiting enhanced resource profiles.

The techniques for employing the resource leveling include exact methods, heuristic methods and meta-heuristic methods.

The exact methods include enumeration, integer programming, and dynamic programming techniques described in Neumann et al., (“Resource leveling for projects with schedule-dependent time windows,” European Journal of Operational Research, Vol. 117, No. 3, Sept.1999, pp. 591-605—incorporated herein by reference) which obtain the global optimal solutions. The literature features research efforts which employ exact methods including Petrovic (“On optimization of resource leveling in project plans,” Lombaers, H. J. (Ed.), Project Planning by Network Analysis, Proceedings of the 2nd International Congress, North-Holland, Amsterdam, 1969, pp. 268-273—incorporated herein by reference), Ahuja (Construction Performance Control by Networks, NY: Wiley,1976—incorporated herein by reference), Easa (“Resource leveling in Construction by Optimization,” Journal of Construction Engineering and Management, Vol. 115, No.2, pp. 302-316—incorporated herein by reference), Younis et al.(“Optimal resource leveling of multi-resource projects,” Computers & Industrial Engineering, Vol. 31, No. 1-2, 1996, pp. 1-4—incorporated herein by reference), and Bandelloni et al. (“Optimal resource leveling using non serial dynamic programming,” European Journal of Operational Research, Vol. 78, No 2,1994, pp. 162-177—incorporated herein by reference). The major drawback of the exact methods is that only the networks of small number of activities can be solved as described in Zhao. This drawback is because of the well-known problem of “combinatorial explosion” which occurs in the networks of big number of activities. This problem features an enormous increase in the number of possible schedules; thus, considerably increasing the solution search space which consequently makes the task of finding the optimal solution by the exact methods cumbersome as described in Leu, S. et al. (“Resource leveling in construction by genetic algorithm-based optimization and its decision support system application,” Automation in Construction, Vol. 10, No. 1, 2000, pp. 27-41—incorporated herein by reference). Another drawback of the exact methods is that only single-resource projects can be handled as described in Neumann et al., hence, they cannot be used to solve large and complex problems effectively which limit their use for practical purposes.

Few heuristic methods were developed in the literature to perform resource leveling include Galbreath (“Computer program for leveling previous resource usage,” Journal of the Construction Division, Vol. 91, 1965, pp. 107-124—incorporated herein by reference), Burgess et al., “Variation in activity level on a cyclical arrow diagram,” Journal of Industrial Engineering, Vol. 13, 1962, pp.76-83—incorporated herein by reference), Son et al. (“Multiheuristic Approach for Resource Leveling Problem in Construction Engineering: Hybrid Approach,” Journal of Construction Engineering and Management, Vol. 125, No. 1,1999, pp. 23-31—incorporated herein by reference), Ahuja, and Harris (“Packing Method for Resource Leveling (Pack),” Journal of Construction Engineering and Management, Vol. 116, No. 2, 1990, pp. 331-350—incorporated herein by reference). These heuristic methods can handle complex problems and have been extensively used in practice as in Zhao. However, there are limitations which restrict the use of these methods in general for construction scheduling. These models are problem dependent, which implies that the rules specific to a model cannot be applied equally for all problems as described in Leu et al. (“Resource leveling in construction by genetic algorithm-based optimization and its decision support system application,” Automation in Construction, Vol. 10, No. 1,2000, pp. 27-41—incorporated herein by reference)

Moreover, the majority of these methods can handle only single resource projects. Further, the optimal solution is not always guaranteed by these models because of different characteristics exhibited by the schedules as described in Zhao. Several meta-heuristics have been used in the literature to solve resource leveling problems. The meta-heuristics provide a generalized and robust approach to resource leveling as they offset the limitations imposed by the exact and heuristic methods. The ant colony optimization (ACO) which simulates the natural auto catalytic behavior of ants to find the shortest path was used for resource leveling. The first model for resource leveling using ACO was developed by Ding et al. (“Applying Ant Colony Optimization to Multiple Resources Leveling Problem,” Energy Procedia, Vol. 13, 2011,pp. 2645-2653—incorporated herein by reference). Later, an improved directional ant colony optimization method was developed by Geng et al. (“An improved ant colony optimization algorithm for nonlinear resource-leveling problems,” Computers & Mathematics with Applications, Vol. 61, No. 8,2011, pp. 2300-2305—incorporated herein by reference) for nonlinear resource leveling optimization problem. The GA has been used extensively to solve resource management problems in general. The earliest GA-based model dates back to the 90's and was developed by Chan et al. (“Construction Resource Scheduling with Genetic Algorithms,” Journal of Construction Engineering and Management, Vol. 122, No 2,1996, pp. 125-132—incorporated herein by reference). Other GA-based models include the models developed by Hegazy (“Optimization of Resource Allocation and Leveling Using Genetic Algorithms,” Journal of Construction Engineering and Management, Vol. 125, No. 3,1999, pp. 167-175—incorporated herein by reference), Leu et al. (“GA-Based Multicriteria Optimal Model for Construction Scheduling,” Journal of Construction Engineering and Management, Vol. 125, No. 6,1999, pp. 420-427—incorporated herein by reference), Senouci et al.(“Use of Genetic Algorithms in Resource Scheduling of Construction Projects,” Journal of Construction Engineering and Management, Vol. 130, No. 6, 2004, pp. 869-877—incorporated herein by reference), and Leu et al. (“Resource leveling in construction by genetic algorithm-based optimization and its decision support system application,” Automation in Construction, Vol. 10, No. 1,2000, pp. 27-41—incorporated herein by reference). A recent study of El-Rayes et al. asserted that the metrics used for reducing resource fluctuations tend to favor a predetermined resource profile which may result in omitting schedules with more efficient resource utilization. Accordingly, El-Rayes et al. developed a set of new metrics to induct the generation of optimal solutions which are impartial to predetermined resource profiles.

The heuristic methods can handle complex problems and have been extensively used in practice. However, there are limitations which restrict the use of these methods in general scheduling. These models are problem dependent, which implies that the rules specific to a model cannot be applied equally for all problems. Moreover, the majority of these methods can handle only single resource projects. Further, the optimal solution is not always guaranteed by these models because of different characteristics exhibited by the schedules.

The meta-heuristics provide a generalized and robust approach to resource leveling as they offset the limitations imposed by the exact and heuristic methods. However, these models are using new metrics which are impartial to predetermined resource profiles to induct the generation of optimal solutions.

Implementing the GAs technique in the problem of resource leveling scheduling involves the steps of: devising a schedule extension scheme; setting chromosome structure; defining the chromosome evaluation criterion; generating an initial population of chromosomes; employing an offspring generation crossover and mutation operators; and coding the procedure in a computer program.

The object of the present invention is, to solve conflicts and achieve the efficient utilization of resource, to provide a project simulation method in which a resource leveling simulation can be performed by exploring solutions of enhanced resource profiles beyond the original project duration.

### SUMMARY OF THE INVENTION

A computer-implemented method for reducing the fluctuation in resource profile allows exploring solutions beyond the original project duration. The computer-implemented method includes: providing computer processing means and computer readable media; inputting a data set including a list of projects to be sorted by the computer processing means, a list of activities to complete the project, duration data associated with each project of the data set, sequence data associated with each project of the data set, a genetic algorithm (GA), an schedule extension scheme, a representation method, an algorithm of generating chromosome of initial population, a selection method of chromosome for reproduction, a resource leveling metric, a cross-over percentage and a mutation percentage; setting an extension increment associated with each project of the data set; formulating a genetic algorithm based model associated with each project of the data set and the GA; calculating an evaluation metric value for each project based upon the sequence data, the duration, the genetic algorithm model, the extension scheme method, the representation method of chromosome, the algorithm of generating chromosome of initial population, the resource leveling metric, the cross-over percentage and the mutation percentage; and displaying an evaluation table which is arranged with the evaluation metric values and durations.

In the first feature, a schedule extension scheme is to add a plurality of days to a total float of each of activities to produce an adjusted total float.

In the first feature, a representation method is a shifting representation which adds a shift value to an activity's early start time to calculate the activity's start time.

In the first feature, a resource leveling metric is selected to reduce the resource fluctuation.

A computerized method of formulating genetic algorithm searches for a plurality of schedules of enhanced resource profile beyond the original duration , which includes: devising a schedule extension scheme; representing chromosomes using a representation method; generating initial population; evaluating chromosomes based on a resource leveling metric; selecting chromosomes and employing crossover and mutation.

In the second feature, a schedule extension scheme is to add a plurality of days to a total float of each of said activities to produce an adjusted total float.

In the second feature, a representation method is a shifting representation which adds a shift value to an activity's early start time to calculate the activity's start time.

In the second feature, a resource leveling metric is selected to reduce the resource fluctuation.

### BRIEF DESCRIPTION OF THE DRAWING

FIG. 1 is a flowchart of a project portfolio simulation method in accordance with an embodiment of the present invention.

FIG. 2 is a flowchart illustrating a procedure of a Genetic Algorithm (GA) model used in the embodiment.

FIG. 3(a) is a chart showing an original CPM schedule with a 13-activity project before application of the project portfolio simulation method of extending project durations according to the present invention. FIG. 3(b) illustrates chromosome of a 13-activity project encoding shift values.

FIG. 4 is a chart showing chromosome of the initial population using a 5-day extension scheme of the 13-activity network.

FIG. 5 is a chart showing the step of algorithm of generating chromosomes of the initial population of the 13-activity project.

FIG. 6 (a) is a chart showing the precedence diagram of the five-activity network. FIG. 6 (b) shows the resource profile of the conventional early-start schedule and the proposed schedule.

FIG. 7 (a) is an evaluation table showing the simulation results for the 30-activity project and FIG. 7 (b) is a chart showing the simulation results of the optimal solution of the 30-activity network with the Release and Re-Hire (RRH) value of 29.

FIG. 8 (a) is an evaluation table showing the simulation results for the 120-activity project and FIG. 8(b) is a chart showing the simulation results of the optimal solution of the 120-activity network with the RRH value of 143.

FIG. 9 is a diagrammatic overview of a system for implementing the method of resource leveling according to the present invention.

### DETAILED DESCRIPTION OF THE PREFERRED EMBODIMENT

A network diagram of a project shows which activities follow and depend from other activities. Critical paths, i.e., routes through the network that will take the longest amount of time, are identified. Activity floats display project activities that can be delayed without affecting the critical paths. A basic network parameter of total float is computed from all of the floats identified in the network. The method allows for an extension scheme method to supplement the total float of the terminating activity of the network with a definite extension increment of a specified number of days, and represents a framework that allows devising schedules of completion times that range from the original duration to the original duration plus the extension increment in order to provide practitioners with schedules of low resource fluctuation and accordingly more efficient utilization of resources.

The extension scheme transforms the process of searching for the schedule of extended duration which minimizes the resource fluctuation from exploration in a boundless solution space to a process of exploration in a well-defined and definite solution space. The definite exploration space allows for the formulation of optimization models, such as genetic algorithm, which search for the optimized resource-leveling solution. The optimum solution would be the schedule of extended duration that is equivalent to the resource profile exhibiting the minimum fluctuation in resource utilization. Even though this is the preferred embodiment, the method does not preclude being implemented in various manifestations other than the one described here.

The extendable network transforms the process of seeking a resource leveling solution that the original project remains intact to a process of searching the resource leveling techniques schedule activities in unconstrained-resource conditions to minimize fluctuation in resource profiles. The method utilizes the mathematical formulation of optimization techniques, such as genetic algorithm, which provides the optimum solution as a schedule that exhibits lower fluctuation beyond the original duration.

The method of exploring resource management solution beyond the original project duration extending activity floats in the critical path method (CPM) comprises three primary stages, including the preparation of the input, the preparation of the CPM network in extension scheme, and the formulation of the genetic algorithm based model of the unconstrained-resource scheduling problem.

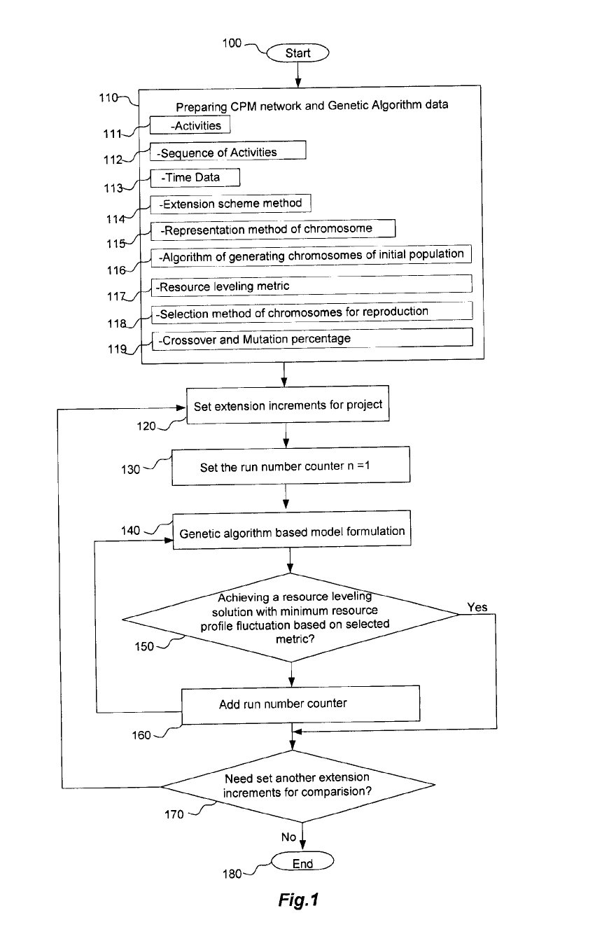

The process flow 100, as shown in FIG. 1, details the searching logic for a solution. The input preparation stage 110 supports preparing CPM schedule and Genetic Algorithm data of the project, which involves activities 111, sequence of activities 112 and time data 113, extension scheme method 114, representation method of chromosome 115, Algorithm of generating chromosomes of initial population 116, resource leveling metric 117, selection method of chromosomes for reproduction 118, cross-over and mutation percentage 119. The time data involves durations, early start times, early finish times, late start times, late finish times, shift values and total floats of activities. At step 120, an extension increment is set by the user. At step 130, the simulation run number account is set to 1. The step 140 formulates the genetic algorithm model. From step 150 to 160, to account for the high randomness feature of the genetic algorithm, genetic algorithm model formulated at 140 are run predetermined times to search for the resource leveling solution with the best resource leveling metric values. Runs are stopped when a certain amount of identical resource leveling metric values are obtained successively. At step 170, user can set other extension increment value and repeat step 130 to 160, and compare the results to find the optimal resource leveling solution with relatively small amount of duration extension. The terminology of method is described below with reference to FIGS. 1, 2, 3 and 4.

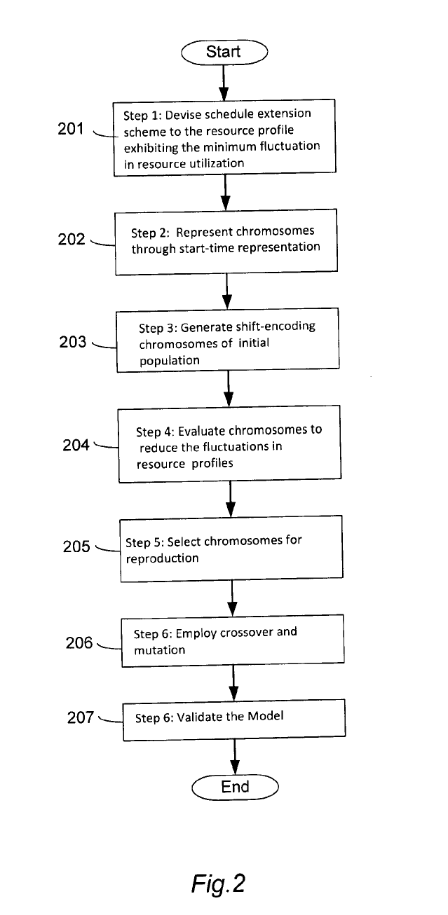

FIG. 2 shows the process 200 for building a genetic algorithm model to search for schedules of enhanced resource profiles beyond the original duration. The process 200 enables the exploration of resource profiles exhibiting lower fluctuation beyond the original duration and allows practitioners achieve more efficient utilization of their resources.

The process 200 begins at 201, wherein an original schedule is devised by an extension scheme. The extension scheme is a special framework that can be used to explore schedules of enhanced resource profiles beyond the original duration. This framework is referred to as the extension scheme from Elazouni et al. (“Finance-Based Scheduling of Construction Projects using Integer Programming,” Journal of Construction Engineering and Management, ASCE, Vol. 130, No. 1, Jan. 2004, pp. 15-24—incorporated herein by reference). The extension scheme transforms the process of searching for the schedule of extended duration which minimizes the resource fluctuation from exploration in a boundless solution space to a process of exploration in a well-defined and definite solution space. The definite exploration space allows for the formulation of optimization models which search for an optimized resource-leveling solution. The optimum solution would be a schedule of extended duration that is equivalent to the resource profile exhibiting the minimum fluctuation in resource utilization.

The extension scheme 114 is a modification in an original CPM network, which supplements the total float of the terminating activity of the network with a definite extension increment of a specified number of days. The extension increment is shared among all the activities of the network. That is, the calculated total floats of the individual activities of the network are supplemented with the same extension increment and the new total floats of the activities are referred to as “extended total floats”. Thus, the extension scheme represents a framework that allows devising schedules of completion times that range from the original duration to the original duration plus the extension increment. The individual activities can be scheduled to start at any time from the early start to the late start plus the extension increment while maintaining the dependency amongst activities.

At 202, a representation method of chromosome 115 is used to represent the candidate's schedule. Like other scheduling problems, the decision variables in the resource leveling problems represent the activities' start times. While chromosome genes encoding activities' start times is an appropriate representation of a candidate' schedule, this representation can cause infeasibility with respect to the precedence relationships, while the chromosome genes encoding activities' shifts Demeulemeester et al. (Project scheduling: a research handbook, 2002, Kluwer Academic Publisher.—incorporated herein by reference) usually will not cause infeasibility with respect to the precedence relationships. In the shift representation, the shift values indicate how many days the activities' start times are delayed beyond the finish times of the preceding activities. The transformation from the shift representation to the start-time representation can be achieved by adding shift values to the respective activities' early start times to calculate the activities' start times.

The activity i=1, 2, . . . ,n, where n is the number of the project activity, the start time of activity is denoted by STi, which can be expressed as:

STᵢ=[rand[0,1]ᵢ*(NSTᵢ+1−max{{FT_{q}|q∈Preᵢ}}]+max{{FT_{q}|q∈Preᵢ}} (1)

Where STᵢ is the start time of activity i, rand[0,1]is a random number generated for activity i in the range from zero to one, NSTᵢ is the late start time of activity i, max {{FT_{q}|q∈Preᵢ}} is the maximum finish time of the predecessors,

The start time STi of the activity i can also be express as:

STᵢ=max{{FT_{q}|q∈Preᵢ}} (2)

Where STᵢ is the start time of activity i and max {{FT_{q}|q∈Preᵢ}} is the maximum finish time of the predecessors.

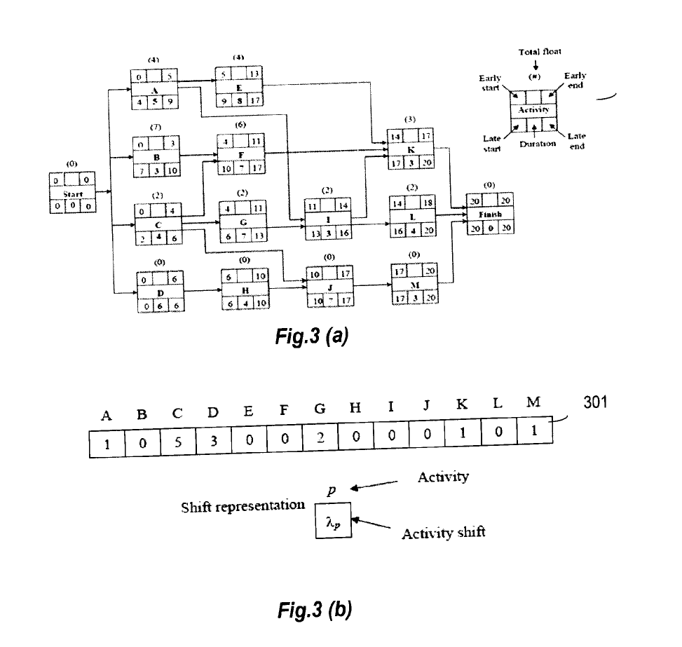

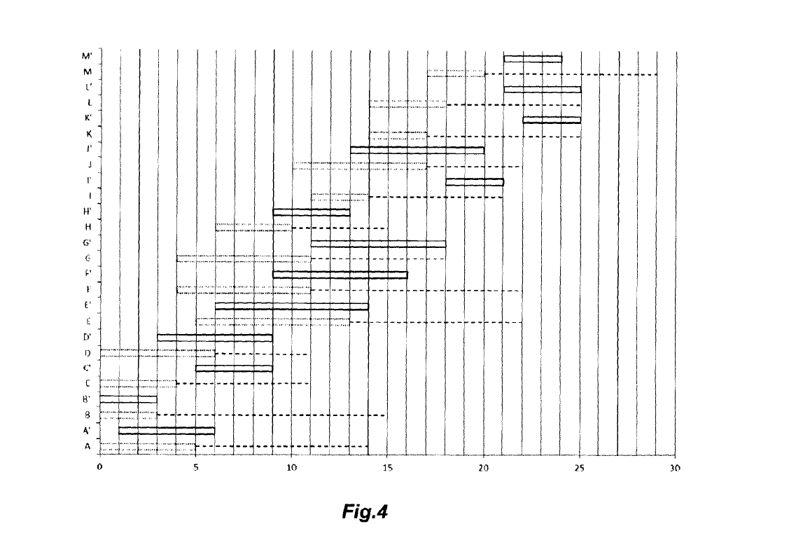

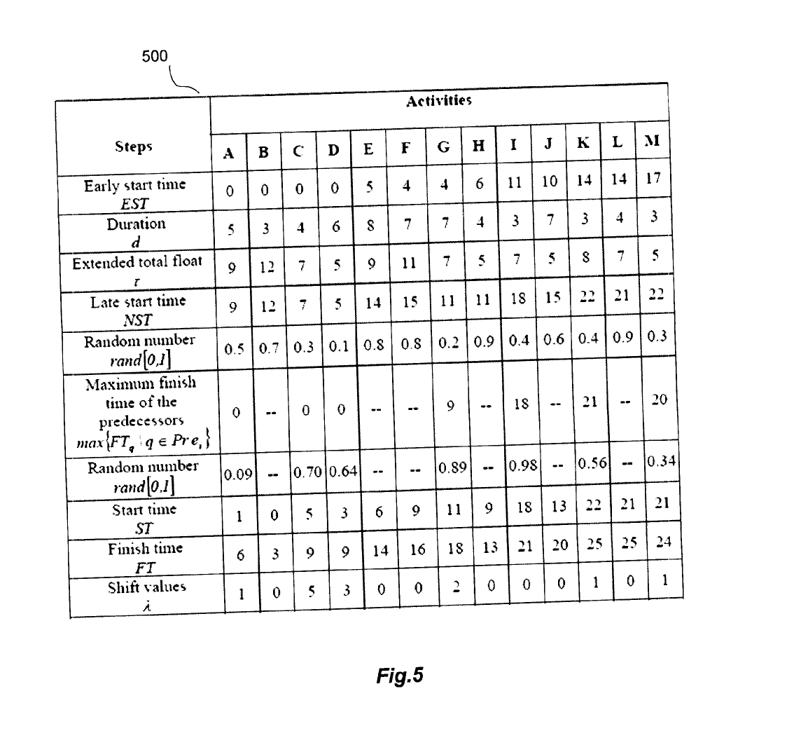

At 203, the generation of the shift-encoding chromosomes of the initial population is presented based on the CPM network shown at 300 in FIG. 3 (a). The five-day extension scheme shown in FIG. 4 is devised for the network shown in FIG. 3 (a). The steps of the algorithm of generating chromosomes of the initial population 116 are outlined in FIG. 4 as explained in Alghazi et al. (“Improved Genetic Algorithm for Finance-based scheduling,” Journal of Computing in Civil Engineering, ASCE, Vol. 27, No. 4, July 2012, pp.379-394—incorporated herein by reference). The activities' late start times NST can be calculated by adding the early start times EST with the respective extended total floats τ. The first step of the algorithm involves the generation of a random number rand [0,1] for each activity in the range from zero to one. The second step of the algorithm is to arbitrarily select a threshold probability P_{shift} in the range from zero to one for shifting activities. In this particular embodiment, 0.6 is selected for the threshold probability for shifting activities. As presented in FIG. 5, activities A, C, D, G, I, K and M exhibited probability values below the threshold of 0.6 and thus undergo some values of shifting. In this case, the start times of activities A, C, D, G, I, K and M are determined using equation (1) whereas the start times of the other activities are determined based on the random number generated for activity i in the range from zero to one (rand [0,1]), the late start time of activity i (NSTᵢ) and the maximum finish time of their respective predecessors (max {{FT_{q}|q∈Preᵢ}}. As shown in FIG. 4, activity B, E, F, H, J and L exhibited probability values larger than the threshold of 0.6, thus, the start time of activity B, E,F, H, J and L are determined by equation (2) whereas the start times are mainly based on the maximum finish time of their respective predecessors(max {{FT_{q}|q∈Preᵢ}}).

The finish time FTq of activity q can be expressed as:

FT_{q}=STₚ+dₚ (3)

where STₚ is the start time of activity p and d is the duration of activity p.

The shift value λₚ of activity p can be expressed as:

λₚ=STₚ−max{{FT_{q}|q∈Preᵢ}} (4)

Where STₚ is the start time of activity p, and max {{FT_{q}|q∈Preᵢ}} is the maximum finish time of the predecessors.

The activities finish time FT is determined by adding the durations d to the start times ST as equation (3) shows. The shifts λ are determined using equation (4) and are presented in the last row in 500 which represents the chromosome structure shown in FIG. 3(b). 301 is chromosome of the 13-activity project encoding shift values.

Release and Re-Hire (RRH) and Resource Idly Days (RID) are two resource leveling metrics which can be used to reduce the fluctuation in resource profile. The metric of RRH is described by equation (5) which is based on equation (6) and (7). The metric of RRD is calculated using equation (8).

RRH=H−MRD=0.5*HR−MRD (5)

HR=(r₁+Σₜ₌₁^{T-1}|rₜ−rₜ₊₁|) (6)

MRD=Max(r₁,r₂, . . . ,r_{T}) (7)

RID=Σₜ₌₁^{T-1}[Min{Max(r₁,r₂, . . . ,rₜ), }] (8)

Where RRH is the metric value of RRH, HR is the total daily resource fluctuations where all increases and decreases in the daily resource demand are summed up; H is the total increases in the daily resource demand; T is the total project duration; rₜ is resource demand on day t; rₜ+1 is the resource demand on day t+1; and MRD is the maximum resource demand during the entire project duration.

At 204, resource leveling metrics 117 are used to reduce the fluctuations in resource profile. Two resource leveling metrics were developed by El-Rayes et al. Release and Re-Hire (RRH) can be chosen to minimize the release and rehire of the additional resources. Resource Idly Days (RID) can be chosen when resource leveling is implemented, un-needed resources are allowed to idle on site till they are needed. The metric of RRH and RID can be calculated as described in equation (5)-(8). In this particular embodiment, RRH is selected as the evaluation criteria to reduce the resource leveling fluctuation. First, the RRH value is calculated for the early-start schedule which is a constant value for the initial schedule. Then, the evolution process of the GA entails the evaluation of the generated chromosomes by calculating their associated RRH values. The fitness of the generated chromosomes is determined by the relative improvement in their RRH values as compared to the RRH value of the initial schedule.

At 205, the selection of the chromosomes for reproduction is performed. The chromosomes with high fitness value in the population are assigned with high priority of selection so that their offspring chromosomes could possibly exhibit higher fitness values. The relative importance of a given chromosome is calculated by dividing the inverse of its RRH value by the inverse of the sum of the RRH values of all the chromosomes. The chromosomes of the low RRH values exhibit higher relative importance and hence, higher probability of selection for the next generation.

A selection method of chromosomes for reproduction 118 is selected for this step. In this particular embodiment, the roulette wheel selection is used as the selection method of chromosomes. The roulette wheel selection of the GA is divided among a specific number of chromosomes to an equal number of ranges that are determined in proportion to the chromosomes' relative importance. The probability of the selection of a given chromosome depends on the size of its range. The chromosome of the highest relative importance occupies the largest range and thus, has the highest probability of selection.

The selection of chromosomes for the next generation can be achieved by generating random number between zero and the sum of the relative importance values, and selecting the chromosome that the generated number falls in its range. For example, the range of the first chromosome is intercepted between zero and its relative importance value. The range of the second chromosome is specified between the relative importance of the first chromosome and the sum of the relative importance values of the two chromosomes. The ranges of the subsequent chromosomes are specified accordingly. When the number of chromosomes in the population is N, N−1 chromosomes are selected for the next generation. The elitism is used to save the best chromosome in every generation during the reproduction process, wherein the chromosome of the lowest RRH value at the current generation is copied into the last chromosome for the next generation.

At 206, crossover and mutation is performed in order to generate chromosomes of new characteristics representing new and different schedule. The percentage of crossover and mutation can be specified by user and the value will not cause the losing the best chromosome in every generation and the ignorance of the elitism. In this step, first, chromosomes are mutated by randomly altering value of one gene in a chromosome based on the mutation percentage. For example, the new gene value is randomly selected from the range between 0 and x−1, wherein the value of the gene to be mutated is x. The single point cut crossover occurs between two chromosomes by selecting a random point for crossover. Then, the two generated child crossover chromosome contain the same genes on the left side of the selected point while the right parts of the two chromosomes interchange. The set of chromosomes that generated after employing the mutation and crossover operations represents the population for the next generation.

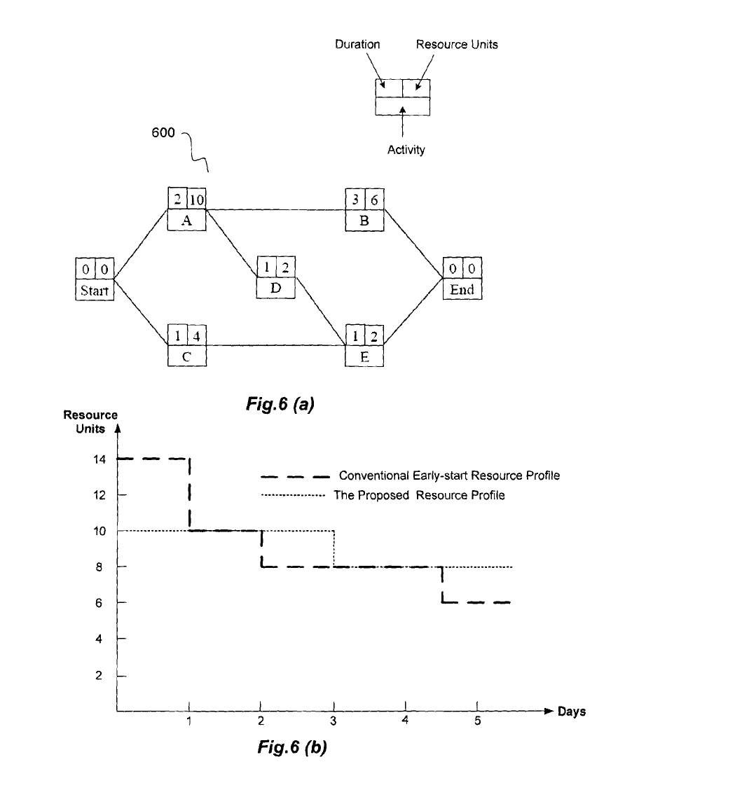

At 207, the resource profile generated by the genetic algorithm described in this invention can be validated by an existed optimization model. In this particular embodiment, an integer-linear optimization model developed by Easa (“Resource leveling in Construction by Optimization,” Journal of Construction Engineering and Management, Vol. 115, No.2, pp. 302-316—incorporated herein by reference), which can produce exact solution for resource leveling problems is used for validation. The exact solution of a small network of five activities minimizing daily resource fluctuations is used as a basis to validate the GA model developed by the present invention. The precedence diagram of the five-activity network 600 is shown in FIG. 6(a). The exact optimum solution of minimizing daily resource fluctuations from Easa is identical to the solution obtained by using the proposed GA model. FIG. 6 (b) shows the resource profile of a conventional early-start schedule and the proposed GA based schedule. The proposed schedule exhibits the reduced daily resource fluctuation. The optimization is performed using the fitness criterion of the RRH. The crossover percentage is 80%, and the mutation percentage is 90%.

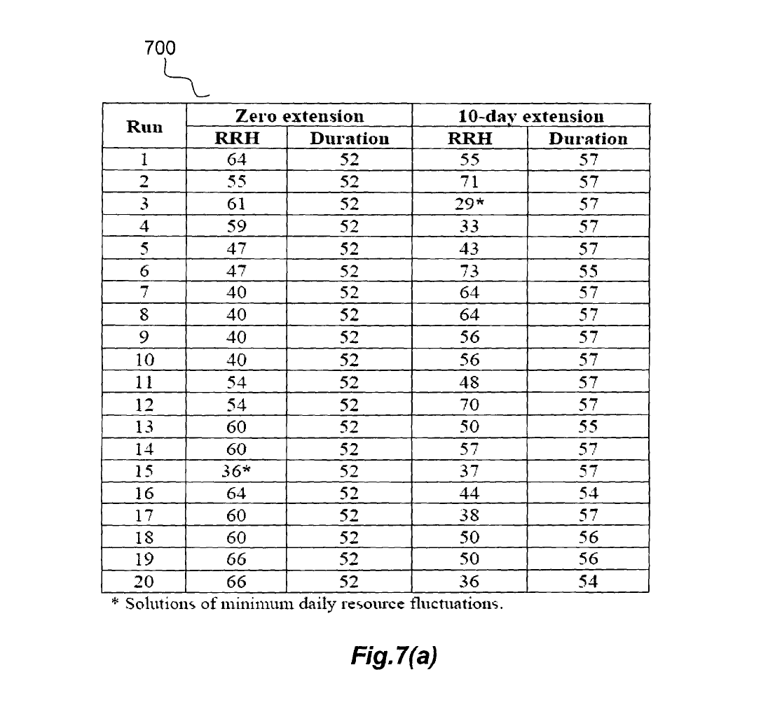

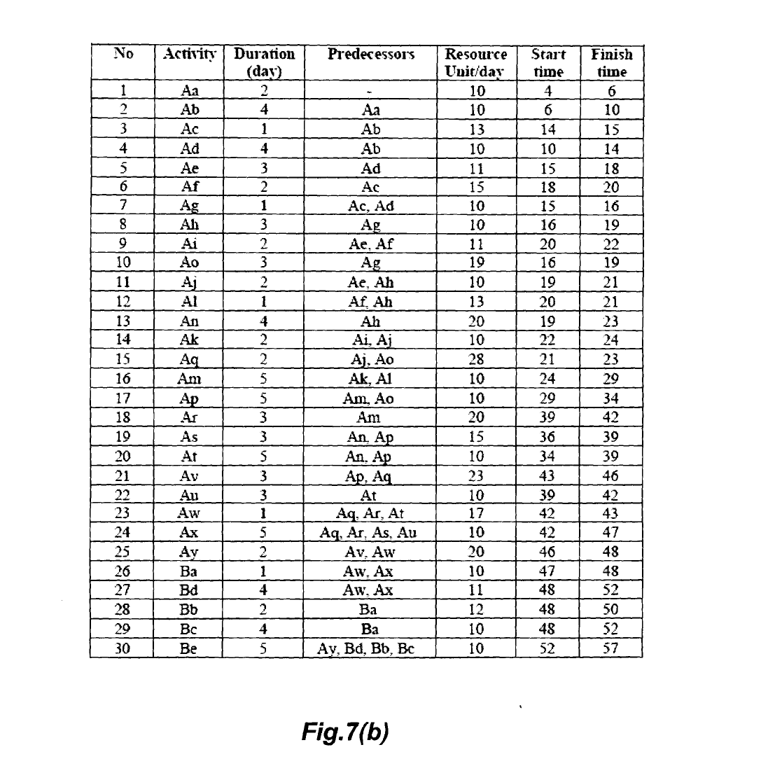

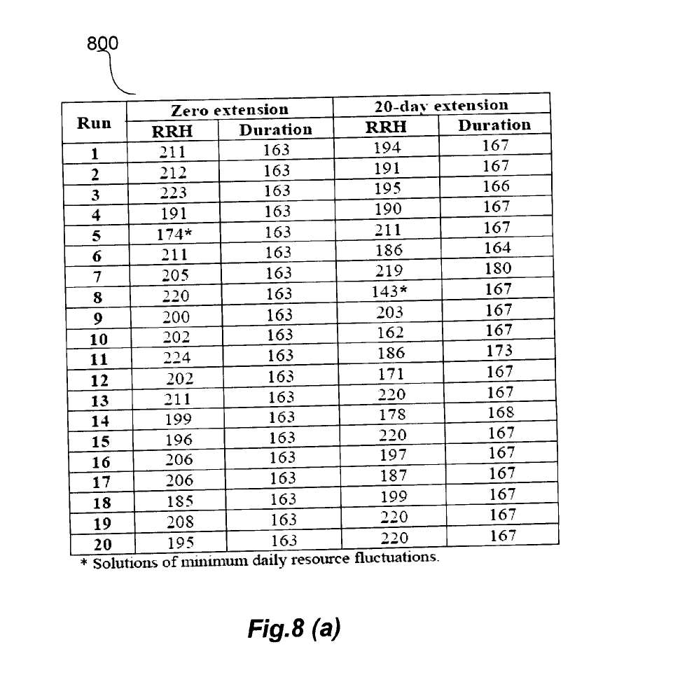

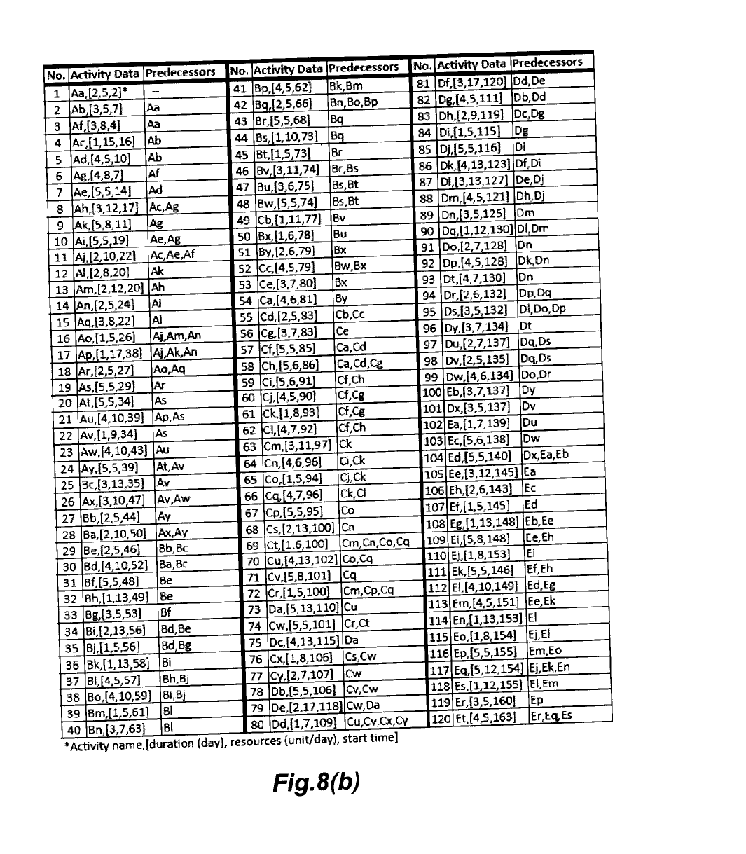

The developed GA resource leveling model is demonstrated using small and large randomly generated networks of 30 and 120 activities as shown in FIG. 7 and FIG. 8. Models considering networks with and without extension increments were run twenty times to search for the optimal solutions exhibiting the minimum RRH values. When ten identical RRH values are obtained successively, the simulation stops. A population size of one hundred, mutation percentage of 99%, and crossover percentage of 99% are used for optimized simulation results.

FIG. 7(a) shows an evaluation table 700 of the results of the 20 runs of the 30-activity networks with zero and 10-day extension increments. The evaluation table 700 is arranged with evaluation metric values and durations for the project. The RRH values ranged between 36 and 64 and between 29 and 73 for networks of zero and 10-day extension increments respectively. The results indicated that increasing the duration from 52 to 57 days resulted in reducing the RRH value from 36 to 29 which is, increasing the duration by 9.6% resulted in reduction in the RRH value of 19.4%.

FIG. 7 (b) presents the data of the 30-activity network and the start and finish times signifying the schedule with the resource profile exhibiting the optimal RRH value of 29.

FIG. 8 (a) shows an evaluation table 800 of the result of 20 runs of the 120-activity networks considering zero and 20 day extension increments. The evaluation table 800 is arranged with evaluation metric values and durations for the project. The RRH values ranged between 174 and 224 and between 143 and 220 for networks of zero and 20-day extension increments respectively. The results indicated clearly that increasing the duration from 163 to 167 days resulted in reducing the RRH from 174 to 143, whereas, increasing the duration by 2.4% resulted in reduction in the RRH value of 17.8%.

FIG. 8(b) presents the data of the 120-activity network and the start times signifying the schedule with the resource profile exhibiting the optimal RRH value of 143.

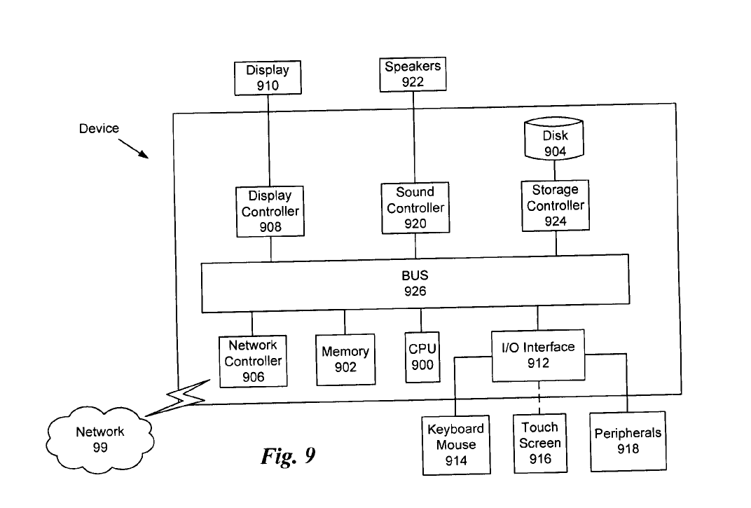

Next, a hardware description of the device according to exemplary embodiments is described with reference to FIG. 9. In FIG. 9, the device includes a CPU 900 which performs the processes described above. The process data and instructions may be stored in memory 902. These processes and instructions may also be stored on a storage medium disk 904 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device communicates, such as a server or computer.

Further, the claimed advancements may be provided as a utility application, background daemon, or component of an operating system, or combination thereof, executing in conjunction with CPU 900 and an operating system such as Microsoft Windows 7, UNIX, Solaris, LINUX, Apple MAC-OS and other systems known to those skilled in the art.

CPU 900 may be a Xenon or Core processor from Intel of America or an Opteron processor from AMD of America, or may be other processor types that would be recognized by one of ordinary skill in the art. Alternatively, the CPU 900 may be implemented on an FPGA, ASIC, PLD or using discrete logic circuits, as one of ordinary skill in the art would recognize. Further, CPU 900 may be implemented as multiple processors cooperatively working in parallel to perform the instructions of the inventive processes described above.

The device in FIG. 9 also includes a network controller 906, such as an Intel Ethernet PRO network interface card from Intel Corporation of America, for interfacing with network 99. As can be appreciated, the network 99 can be a public network, such as the Internet, or a private network such as an LAN or WAN network, or any combination thereof and can also include PSTN or ISDN sub-networks. The network 99 can also be wired, such as an Ethernet network, or can be wireless such as a cellular network including EDGE, 3G and 4G wireless cellular systems. The wireless network can also be WiFi, Bluetooth, or any other wireless form of communication that is known.

The device further includes a display controller 908, such as a NVIDIA GeForce GTX or Quadro graphics adaptor from NVIDIA Corporation of America for interfacing with display 910, such as a Hewlett Packard HPL2445w LCD monitor. A general purpose I/O interface 912 interfaces with a keyboard and/or mouse 914 as well as a touch screen panel 916 on or separate from display 910. General purpose I/O interface also connects to a variety of peripherals 918 including printers and scanners, such as an OfficeJet or DeskJet from Hewlett Packard.

A sound controller 920 is also provided in the device, such as Sound Blaster X-Fi Titanium from Creative, to interface with speakers/microphone 922 hereby providing sounds and/or music.

The general purpose storage controller 924 connects the storage medium disk 904 with communication bus 926, which may be an ISA, EISA, VESA, PCI, or similar, for interconnecting all of the components of the device. A description of the general features and functionality of the display 910, keyboard and/or mouse 914, as well as the display controller 908, storage controller 924, network controller 906, sound controller 920, and general purpose I/O interface 912 is omitted herein for brevity as these features are known.

It is to be understood that the present invention is not limited to the embodiments described above, but encompasses any and all embodiments within the scope of the following claims.

1. A computer-implemented method for reducing the fluctuation in resource profile by adding an extension increment to the duration of a schedule, comprising:
inputting, using a computer device, a data set including a list of projects;
inputting, using a computer device, activities including a list of activities to complete said project;
inputting, using a computer device, duration data associated with each said project of the data set, said duration data including time of completion for each said project;
inputting, using a computer device, sequence data associated with each said project of the data set;
inputting , using a computer device, a genetic algorithm;
inputting, using a computer device, an schedule extension scheme associated with said genetic algorithm;
inputting, using a computer device, a representation method associated with said genetic algorithm;
inputting, using a computer device, an algorithm of generating chromosome of initial population associated with said genetic algorithm;
inputting, using a computer device, a selection method of chromosome for reproduction with said genetic algorithm;
inputting, using a computer device, a resource leveling metric associated with said genetic algorithm;
inputting, using a computer device, a cross-over percentage and a mutation percentage associated with said genetic algorithm;
setting, using a computer device, an extension increment associated with each said project of the data set;
formulating, using a computer device, a genetic algorithm based model associated with each said project of the data set and said genetic algorithm;
calculating, using a computer device, an evaluation metric value for each said project based upon said sequence data, said duration data, said genetic algorithm, said genetic algorithm model, said extension scheme method, said representation method of chromosome, said algorithm of generating chromosome of initial population, said resource leveling metric, said cross-over percentage and said mutation percentage; and
displaying, using a computer device, an evaluation table, and said evaluation table is arranged with said evaluation metric value and said duration for each said project.

2. The computer-implemented method of claim 1 wherein said schedule extension scheme is to add a plurality of days to a total float of each of said activities to produce an adjusted total float.

3. The computer-implemented method of claim 1 wherein said representation method is a shifting representation which adds a shift value to said activity's early start time to calculate said activity's start time.

4. The computer-implemented method of claim 1 wherein said resource leveling metric is selected to reduce the resource leveling fluctuation.

5. A computerized method of formulating genetic algorithm to search for a plurality of schedules of enhanced resource profile beyond the original duration , comprising the steps of :
devising, using a computer device, a schedule extension scheme;
representing, using the computer device, chromosomes through a representation method for activities' start time
generating, using the computer device, initial population
evaluating, using the computer device, chromosomes based on a resource leveling metric
selecting, using the computer device, chromosomes
employing, using the computer device, crossover and mutation operations to obtain the set of chromosomes representing the population for the next generation

6. The computer-implemented method of claim 5 wherein said schedule extension scheme is to add a plurality of days to a total float of each of said activities to produce an adjusted total float.

7. The computer-implemented method of claim 5 wherein said representation method is a shifting representation which adds a shift value to said activity's early start time to calculate said activity's start time.

8. The computer-implemented method of claim 5 wherein said resource leveling metric is selected to reduce the resource leveling fluctuation.
